(19) United States
(12) Patent Application Publication
(10) Pub. No.: US 2020/0080661 A1
(43) Pub. Date: Mar. 12, 2020

(54) HYDRAULIC FLUID PUMP AND RETAINER ASSEMBLY FOR SAME

(71) Applicant: GARDNER DENVER PETROLEUM PUMPS, LLC, Tulsa, OK (US)

(72) Inventors: Chance Ray Mullins, Tulsa, OK (US); Robert James Dyer, Coweta, OK (US); Peter Ross Ehlers, Tulsa, OK (US)

(21) Appl. No.: 16/127,741

(22) Filed: Sep. 11, 2018

(51) Int. Cl. F16K 27/12; F01L 25/06; F04B 39/14; F04B 53/22; F04B 1/12

(52) U.S. Cl. CPC F16K 27/12; F01L 25/066; F16K 5/08; F04B 53/22; F04B 1/122; F04B 39/14

(57) ABSTRACT

A fluid end assembly of a hydraulic fluid pump includes a housing having an axial bore, a removable valve cover closing the axial bore, and a retainer engaging the axial bore. The retainer includes a central opening. The fluid end assembly further includes a threaded drive member positioned within the central opening and operable to apply a preload against the retainer.

### FIELD OF THE INVENTION

The present invention relates to a hydraulic fluid pump and, more particularly, to a fluid end assembly of a hydraulic fluid pump.

### SUMMARY

In one embodiment, the invention provides a fluid end assembly of a hydraulic fluid pump. The fluid end assembly includes a housing having an axial bore, a removable valve cover closing the axial bore, and a retainer engaging the axial bore. The retainer includes a central opening. The fluid end assembly further includes a threaded drive member positioned within the central opening and operable to apply a preload against the retainer.

In another embodiment, the invention provides a method of assembling a fluid end assembly of a hydraulic fluid pump. A removable valve cover is inserted into an axial bore of a housing of the fluid end assembly. The removable valve cover closes and seals the axial bore. A threaded drive member engages one of the valve cover or a retainer. The retainer engages the axial bore of the housing. The threaded drive member is positioned within a central opening of the retainer. A preload is applied against the retainer by rotating the threaded drive member relative to the retainer and the valve cover.

Other aspects of the invention will become apparent by consideration of the detailed description and accompanying drawings.

### BRIEF DESCRIPTION OF THE DRAWINGS

FIG. 1 is a perspective view of a hydraulic fluid pump

FIG. 2 is a cross-sectional view of a fluid end assembly of the hydraulic fluid pump.

FIG. 3 is a perspective view of a retainer preloaded by a drive screw.

FIG. 4 is a cross-sectional view of the retainer and the drive screw of FIG. 3 relative to a valve cover.

FIG. 5 is a cross-sectional view of a retainer and a drive screw having a load ring.

FIG. 6 is a cross-sectional view of a retainer and a drive screw having a load ring, according to another embodiment.

FIG. 7 is a perspective view of a retainer preloaded by a drive nut.

FIG. 8 is a cross-sectional view of the retainer and the drive nut of FIG. 7 relative to a valve cover.

FIG. 9 is a cross-sectional view of a retainer and a drive screw, the retainer having a bayonet-style attachment structure.

FIG. 10 is a cross-sectional view of the retainer and drive nut of FIG. 9 through section line 10-10.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

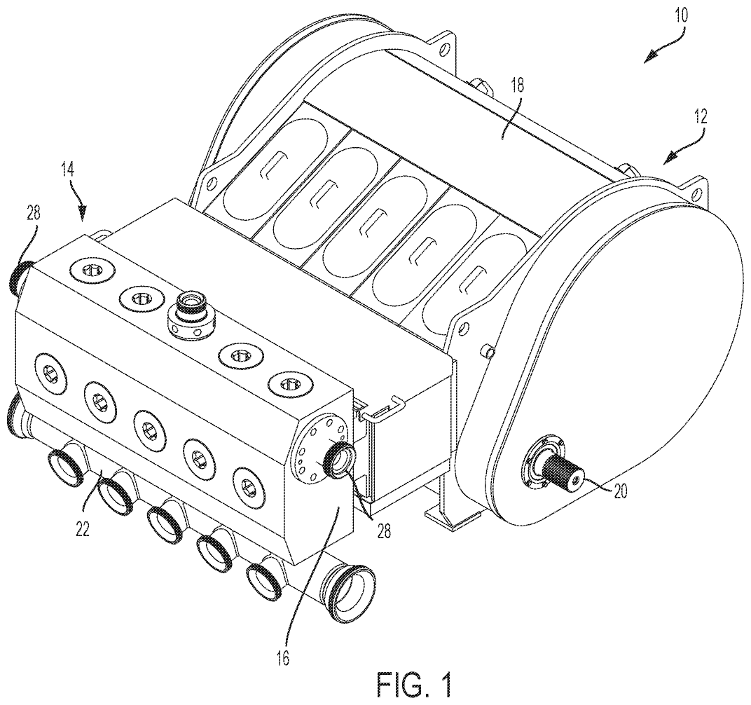

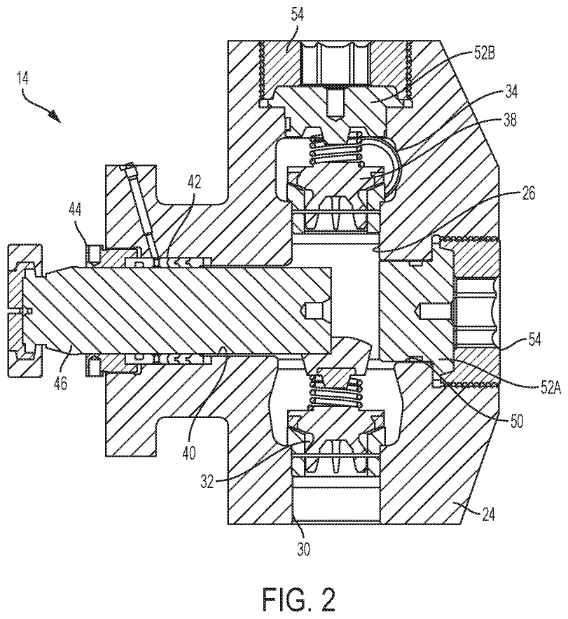

FIG. 1 illustrates a hydraulic fluid pump 10 of the type often used during drilling and hydraulic fracturing operations such as hydrocarbon or oil fracturing. The hydraulic fluid pump 10 includes a drive end or drive end assembly 12 that is largely enclosed within a casing 18. A fluid end or fluid end assembly 14 attaches to the drive end 12 and the casing 18 and includes at least one fluid end block 16. A drive shaft 20 extends out of the casing 18 and provides for a connection point for a prime mover such as a motor or engine. The prime mover drives the drive shaft 20 at a desired speed to power the drive end 12. The drive end 12 typically includes a transmission (e.g., gears, belts, chains, etc.) that serve to step down the speed of the drive shaft 20 to a speed appropriate for the fluid end 14. The drive end 12 includes a series of reciprocating mechanisms that in turn drives a piston or plunger (e.g., piston 46 shown in FIG. 2) within a respective bore of the fluid end block 16 to pump a fluid.

The fluid end 14 is better illustrated in FIG. 2. A housing 24 defines the main body of the fluid end assembly 14 surrounding an interior volume 26. An inlet manifold 22 (FIG. 1) distributes fluid to an inlet bore 30 of each fluid end block 16. An inlet valve 32 is positioned in the inlet bore 30 to control flow from the inlet manifold 22 into the interior volume 26 of the fluid end 14, and more specifically, the interior volume 26 of the housing 24. An outlet bore 34 directs pressurized fluid from the interior volume 26, past an outlet valve 38, and to an outlet manifold integrated into the fluid end 14 and having an outlet 28 (FIG. 1) from the fluid end 14. The outlet manifold 28 is in fluid communication with the fluid end block 16 via the outlet bore 34 and outlet valve 38. As shown, the inlet and outlet bores 30, 34 are axially aligned with one another.

A piston bore 40 extends perpendicular to the inlet and outlet bores 30, 34 and supports a packing arrangement 42 and piston retainer 44. The reciprocating piston 46 is movable within the piston bore 40 relative to the packing arrangement 42 and the retainer 44 to pressurize fluid within the interior volume 26 and to the outlet manifold 28. A service bore 50 is formed in the housing 24 parallel with and axially aligned with the piston bore 40 and provides access to the interior volume 26 of the housing 24 without removal of the piston 46, or the valves 32, 38. The service bore 50 may additionally provide access for insertion and removal of the piston 46 and valve 32 from the remainder of the pump 10.

As shown, both the outlet bore 34 and the service bore 50 include valve covers 52A, 52B and retainers 54. The valve covers 52A, 52B seal against the housing 24 to prevent fluid from the interior volume 26 from passing through the respective bores 34, 50. Each retainer 54 applies a force to the respective valve cover 52A, 52B to hold the valve cover 52 in a sealing position against the housing 24. When the reciprocating piston 46 increases the pressure of the fluid within the interior volume 26 of the housing 24, a force is applied on the valve covers 52A, 52B (either directly, as with the valve cover 52A of the service bore 50, or indirectly, as with the valve cover 52B of the outlet bore 34). The retainer 54 applies a preload to the valve cover 52A, 52B to counteract the force applied by the pressurized fluid and to prevent unseating of the valve cover 52A, 52B from the housing 24.

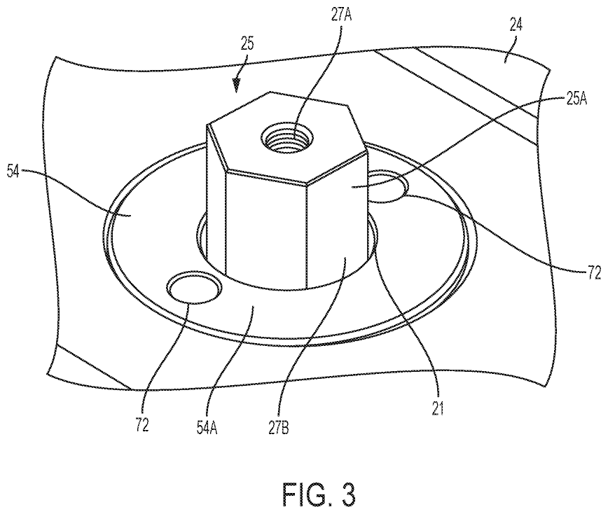

Retainer assemblies 58, 158, 258, 358, 458 include the retainer 54, 154, 254, 354, 454, a threaded drive member 25, 125, 225, 325, 425, and may additionally include a load ring 135, 235. The retainer assemblies 58, 158, 258, 358, 458 and valve covers 52A, 152A, 252A, 352A, 452A shown in FIGS. 3-10 are illustrated with respect to the service bore 50, 150, 250, 350, 450. However, the retainer assemblies 58, 158, 258, 358, 458 can be equally applied to the outlet bore 34 in combination with the valve cover 52B.

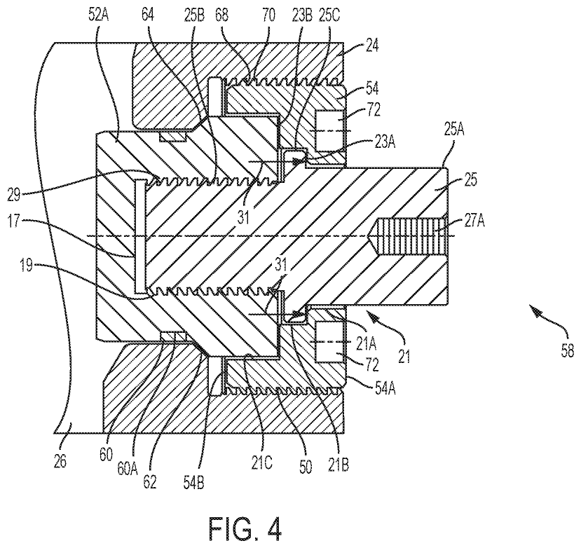

As shown in FIGS. 3 and 4, the valve cover 52A is inserted into the service bore 50 and includes a radial seal 60 positioned within a channel 60A in the valve cover 52A to provide a seal between the valve cover 52A and the housing 24. The valve cover 52A can additionally or alternatively be provided with an axial seal to engage the housing 24. The valve cover 52A is generally cylindrical with a diameter similar to the diameter of the bore 50. The valve cover 52A includes a central recess 17, axially aligned with the axis of the bore 50. The recess 17 includes internal threads 19 along an axial length of the recess 17. To limit potential leakage points, the recess 17 does not extend through the entirety of the valve cover 52A, but rather extends from a first side and terminates prior to a second side of the valve cover 52A. The valve cover 52A further includes a lip portion 62 for engaging a chamfer or step 64 in the service bore 50 to limit the axial insertion distance of the valve cover 52A and to provide a further seat or interface between the housing 24 and the valve cover 52A. The valve cover 52A is not threaded or otherwise fastened to the bore 50, outside of a clearance fit and/or friction provided by the radial seal 60.

The bore 50 shown in FIGS. 3 and 4 is a threaded bore having internal threads 68 extending axially through at least a portion of the bore 50. The retainer 54 includes external threads 70 that mate with the internal threads 68 of the bore 50. As shown, the threads 68, 70 include an angled portion and a radial (vertical) portion. The radial interface of the threads 68, 70 provides resistance against axial forces applied on the valve cover 52A (and therefore the retainer 54) perpendicular to the radial interface of threads 68, 70. In some embodiments, the threads 68 extend to a depth such that the retainer 54 can be threaded into abutment with the valve cover 52A when the valve cover 52A is in the sealing position. The retainer 54 further includes an engagement feature 72. The engagement feature 72 shown in FIGS. 3 and 4 includes two recesses in a first axial end 54A of the retainer 54 and is engageable by an adjustment tool, such as a spanner wrench. When engaged by the adjustment tool, an operator is able to able to threadedly insert the retainer 54 into the bore 50 and into engagement with the valve cover 52B.

The retainer 54 further includes a central opening 21 that extends axially through the retainer 54 from the first axial end 54A of the retainer 54 to a second axial end 54B of the retainer 54. The central opening 21 is centered within the retainer 54 such that a central axis of the opening 21 is collinear with an axis of the bore 50. The central opening 21 includes three portions, a first portion 21A extending from the first axial end 54A of the retainer 54, a second portion 21B extending from the first portion 21A, and a third portion 21C extending from the second portion 21B to the second axial end 54B of the retainer 54. The first, second, and third portions 21A, 21B, 21C have increasing cross-sectional areas, respectively, such that steps and annular surfaces 23A, 23B are defined at the interfaces between the portions 21A, 21B, 21C.

A threaded drive member, embodied as a drive screw 25, is inserted into the central opening 21, as shown in FIG. 4. The drive screw 25 extends axially and includes an engagement portion 25A at a first end, a threaded region 25B at a second end, opposite the first end, and a radial protrusion 25C located between the tool engagement and threaded regions 25A, 25B. The engagement portion 25A includes one or both of an internal engagement feature 27A (FIGS. 3-4; e.g., a threaded aperture, an internal hex interface, etc.) and an external engagement feature 27B (FIG. 3; e.g., an external hex interface, external threads, etc.). The engagement feature 27A, 27B of the engagement portion 25A is engageable from outside of the retainer 54 when assembled within the bore 50 to rotate the drive screw 25 relative to the bore 50, the retainer 54, and the valve cover 52A.

As shown, the engagement portion 25A extends axially outward (away from the valve cover 52A) from the retainer 54, thereby permitting a tool (e.g., a wrench) to engage an outer periphery of the drive screw 25 at the engagement portion 25A. In other embodiments, the drive screw 25 can terminate within the central opening 21 such that the periphery of the drive screw is not accessible, and the internal engagement feature 27A is engaged to rotate the drive screw 25. As a further alternative, if the drive screw 25 terminates within the central opening 21, the first portion 21A of the central opening 21 may define a radial gap such that a tool is insertable around the drive screw 25 within the opening 21.

The threaded region 25B of the drive screw 25 is cylindrical and includes external threads 29 that engage the internal threads 19 of the valve cover 52A. When the threads 19, 29 are engaged, the drive screw 25 is coupled to the valve cover 52A.

The radial protrusion 25C is positioned between the tool engagement and threaded regions 25A, 25B and extends radially outward relative to the tool engagement region 25A to engage the annular surface 23A. As shown, the radial protrusion 25C is cylindrical, though in other embodiments, the radial protrusion may be one or more lobes or distinct and spaced apart radial protrusions. The radial protrusion 25C is also shown as having a diameter greater than the threaded region 25B, though in other embodiments, the radial protrusion may have a diameter that is equal to or less than a diameter of the threaded region 25B. In some embodiments, the radial protrusion 25C may be integral with the threaded region 25B. Though the mating surfaces of the annular surface 23A and the radial protrusion 25C are shown as being perpendicular to the axis of the bore 50, the surfaces may otherwise be angled or tapered relative to the axis of the bore 50.

In operation, to preload the removable valve cover 52A (or, alternatively, the removable valve cover 52B), the valve cover 52A is inserted into the bore 50 and is seated against the step 64, with the radial seal 60 blocking a leakage path from the interior volume 26 of the housing 24. The drive screw 25 is threaded onto the threads 19 of the valve cover 52A, thereby inserting the threaded region 25B of the drive screw 25 into the recess 17 of the valve cover 52A. Once the drive screw 25 is threaded into the valve cover 52A, the retainer 54 is threaded onto the internal threads 68 of the bore 50 until the annular surface 23B of the retainer 54 engages (e.g., abuts, contacts) the valve cover 52A. Once in contact, torque is applied to the drive screw 25 to unthread the drive screw 25 an axial distance relative to the valve cover 52A (e.g., a few rotations), though the drive screw 25 is still threaded to the valve cover 52A. The drive screw 25 is unthreaded until the radial protrusion 25C engages (e.g., contacts, abuts) the annular surface 23A of the retainer 54. Once the drive screw 25 is in axial contact with the annular surface 23A, an operator applies torque to one of the engagement features 27A, 27B to apply an axial applied force (as shown by arrow 31) against the annular surface 23A of the retainer 54. This applied force is transferred through the retainer 54 to the interface between the threads 68, 70 and likewise through the drive screw 25 to the interface between the threads 19, 29. Preloading the valve cover 52A prevents or limits seal movement when pressure is applied in the internal volume 26 of the housing 24.

In operation, to remove the retainer assembly 58, the drive screw 25 is rotated (e.g., by a wrench engaging the engagement feature 27A, 27B) to axially translate further into the recess 17 of the valve cover 52A and away from the annular surface 23A of the retainer 54 to remove the preload. Once the preload is fully removed by loosening the drive screw 25, the retainer 54 is rotated relative to the bore 50 until fully unthreaded. At that time, the drive screw 25 can be fully unthreaded from the valve cover 52A and the valve cover 52A can be accessed for removal or inspection. Alternatively, the valve cover 52A and drive screw 25 may be removed together.

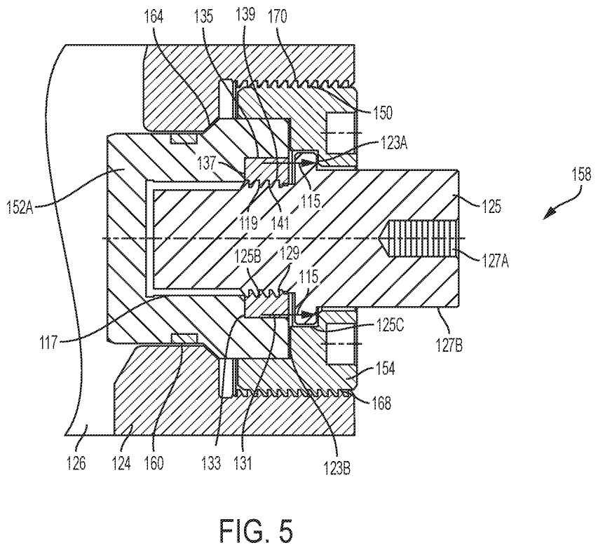

FIG. 5 illustrates another embodiment of the invention. Like elements are indicated by like reference numerals incremented by 100 and are similar to those elements shown in FIGS. 3-4 except as otherwise described.

As shown in FIG. 5, the recess 117 of the valve cover 152A is modified relative to the bore 17 shown in FIGS. 3-4. The recess 117 includes a cutout or step 131 in which a load ring 135 is positioned. More specifically, the cutout 131 includes a transverse surface 133 (e.g., extending transverse to the axis of the bore 50) against which the load ring axially engages (e.g., abuts, contacts). Further, the recess 117 is unthreaded.

The load ring 135 includes an external cross-section sized to fit within the cutout 131 and further includes a transverse surface 137 for engaging the mating transverse surface 133 of the valve cover 152A. The cutout 131 may include a non-circular cross-section (e.g., a polygonal cross-section, a keyed circular or non-circular cross-section). The load ring 135 may include a similar external cross-section to mate with the cutout 131 such that when the load ring 135 is inserted into the cutout 131, the load ring 135 is not rotatable relative to the valve cover 152A.

The load ring 135 further includes a threaded channel 139 having a plurality of threads 141 for engaging the threads 129 of the drive screw 125. When positioned within the cutout 131, the threaded channel 139 is axially aligned (i.e., collinear) with the axis of the bore 50. The threads 129 of the drive screw 125 only extend along the portion of the drive screw 125 that engages the load ring 135 when installed, as shown in FIG. 5. In other embodiments, the drive screw 125 may terminate at the end of the threads 129 such that the drive screw 125 does not extend axially beyond the transverse surface 133 of the valve cover 152A. Likewise, the recess 117 may terminate at the annular surface 137. As a further alternative, the drive screw 125 may be fully threaded along the length of the drive screw 125 within the recess 117, the recess 117 having a cross-sectional area great enough so as to not engage or otherwise interfere with the threads 129.

In operation, to preload the removable valve cover 152A (or, alternatively, the removable valve cover 152B), the valve cover 152A is inserted into the bore 150 and is seated against the step 164, with the radial seal 160 blocking a leakage path from the interior volume 126 of the housing 124. The load ring 135 is inserted into the cutout 131 in the valve cover 152A such that the annular surface 137 of the load ring 135 axially engages (e.g., contacts, abuts) the transverse surface 133 of the valve cover 152A. The threaded channel 139 of the load ring 135 is axially aligned with the central axis of the bore 150. The drive screw 125 is threaded onto the threads 141 of the threaded channel 139 load ring 135, thereby inserting the threaded region 125B of the drive screw 125 into the recess 117 of the valve cover 152A. The load ring 135 may alternatively be threaded onto threads 129 of the drive screw 125 prior to inserting the combined load ring 135 and drive screw 125 into the valve cover 152A by locating the load ring 135 within the cutout 131. Installing the load ring 135 and drive screw indirectly couples the drive screw 125 to the valve cover 135. Once the drive screw 125 and load ring 135 are positioned relative to the valve cover 152A, the retainer 154 is threaded onto the internal threads 168 of the bore 150 until the annular surface 123B of the retainer 154 engages (e.g., abuts, contacts) the valve cover 152A. Once in contact, torque is applied to the drive screw 125 to unthread the drive screw 125 an axial distance relative to the load ring 135 (e.g., a few rotations), though the drive screw 125 is still threaded to the load ring 135. The cross-sectional shapes of the cutout 131 and the load ring 135 prevent the load ring 135 from rotating relative to the valve cover 152A such that the drive screw 125 is rotatable relative to the load ring 135. The drive screw 125 is unthreaded from the load ring 135 until the radial protrusion 125C engages (e.g., contacts, abuts) the annular surface 123A of the retainer 154. Once the drive screw 125 is in axial contact with the annular surface 123A, an operator applies torque to one of the engagement features 127A, 127B to apply an axial applied force (as shown by arrow 115) against the annular surface 123A of the retainer 154. This applied force is transferred through the retainer 154 to the interface between the threads 168, 170 and likewise through the drive screw 125 to the interface between the threads 141, 129. The axial force applied at the threads 141, 129 is transferred to the interface between the transverse surfaces 133, 137 such that the load ring 135 applies the preloading force to the valve cover 152A. Preloading the valve cover 152A prevents or limits seal movement when pressure is applied in the internal volume 126 of the housing 124.

In operation, to remove the retainer assembly 158, the drive screw 125 is rotated (e.g., by a wrench engaging the engagement feature 127A, 127B) to axially translate further into the recess 117 of the valve cover 152A and away from the annular surface 123A of the retainer 154 to remove the preload. Once the preload is fully removed by loosening the drive screw 125, the retainer 154 is rotated relative to the bore 150 until fully unthreaded. At that time, the drive screw 125 can be fully unthreaded from the load ring 135 or the drive screw 125 and the load ring 135 can be axially removed from the recess 117, and the valve cover 152A can be accessed for removal or inspection.

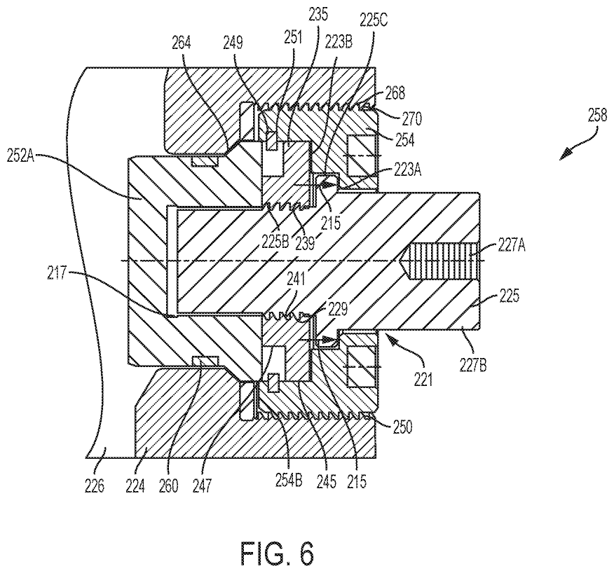

FIG. 6 illustrates another embodiment of the invention. Like elements are indicated by like reference numerals incremented by 200 (relative to the embodiment shown in FIGS. 3-4) and are similar to those elements shown in FIGS. 3-4 and 5 except as otherwise described.

As shown in FIG. 6, the valve cover 252A is modified relative to the valve covers 52, 152 to decrease the axial length of the valve cover 252A to provide space for a load ring 235, modified relative to the load ring 135 shown in FIG. 5. The load ring 235 is positioned within the central opening 221 and includes a first portion 245 sized to engage the annular surface 223B and a second portion 247 having a lesser diameter than the first portion 245 and sized to engage (e.g., axially abut) the valve cover 252. A fastener 249 extends into the central opening 221 adjacent the second axial end 254B of the retainer 254 to hold the load ring 235 within the central opening 221. As shown, the fastener 249 is a snap ring that is inserted into an annular groove 251 of the retainer 254. Alternatively, the fastener may include, for example, one or more threaded fasteners extending radially into the central opening 221, or a radially-biased detent feature (e.g., spring biased detent). The load ring 235 is stepped such that the load ring can simultaneously contact the retainer 254 and the valve cover 252A while still providing space for the fastener 249.

The load ring 235 includes a threaded channel 239 extending axially through both of the portions 245, 247 of the load ring and includes internal threads 241 for engaging the threads 229 in the threaded region 225B of the drive screw 225. Similar to the embodiment shown in FIG. 5, the threads 229 of the drive screw 225 only extend along the portion of the drive screw 225 that engages the load ring 235 when installed. In other embodiments, the drive screw 225 may terminate at the end of the threads 229 such that the drive screw 225 does not extend within the valve cover 252A. Likewise, the drive screw 225 may be provided without the recess 217. As a further alternative, the drive screw 225 may be fully threaded along the length of the drive screw 225 within the recess 217, the recess 217 having a cross-sectional area great enough so as to not engage or otherwise interfere with the threads 229.

In operation, to preload the removable valve cover 252A (or, alternatively, the removable valve cover 252B), the valve cover 252A is inserted into the bore 250 and is seated against the step 264, with the radial seal 260 blocking a leakage path from the interior volume 226 of the housing 224. The load ring 235 is threaded onto the drive screw 225 and the drive screw 225 is inserted through the central opening 221 of the retainer 254 until the load ring 235 engages (e.g., abuts, contacts) the annular surface 223B of the retainer 254. The fastener 249 is then positioned to extend into the central opening 221. As shown, this includes placing the snap ring 249 into the annular channel 251. The fastener 249 prevents removal of the load ring 235 from the central opening 221 (without first removing the fastener 249). The retainer assembly 258 (including the retainer 254, the drive screw 225, the load ring 235, and the fastener 249) is threaded onto the internal threads 268 of the bore 250 until the second portion 247 of the load ring 235 engages (e.g., abuts, contacts) the valve cover 252A. Once in contact, torque is applied to the drive screw 225 to unthread the drive screw 225 an axial distance relative to the load ring 235 (e.g., a few rotations), though the drive screw 225 is still threaded to the load ring 235. The cross-sectional shapes of the cutout 231 and the load ring 235 prevent the load ring 235 from rotating relative to the valve cover 252A such that the drive screw 225 is rotatable relative to the load ring 235. The drive screw 225 is unthreaded from the load ring 235 until the radial protrusion 225C engages (e.g., contacts, abuts) the annular surface 223A of the retainer 254. Once the drive screw 225 is in axial contact with the annular surface 223A, an operator applies torque to one of the engagement features 227A, 227B to apply an axial applied force (as shown by arrow 215) against the annular surface 223A of the retainer 254. This applied force is transferred through the retainer 254 to the interface between the threads 268, 270 and likewise through the drive screw 225 to the interface between the threads 241, 229. The axial force applied at the threads 241, 229 is transferred to the axial interface between the second portion 247 and the valve cover 252A such that the load ring 235 applies the preloading force to the valve cover 252A. Preloading the valve cover 252A prevents or limits seal movement when pressure is applied in the internal volume 226 of the housing 224.

In operation, to remove the retainer assembly 258, the drive screw 225 is rotated (e.g., by a wrench engaging the engagement feature 227A, 227B) to axially translate further into the recess 217 of the valve cover 252A and away from the annular surface 223A of the retainer 254 to remove the preload. Once the preload is fully removed by loosening the drive screw 225, the retainer 254 is rotated relative to the bore 250 until fully unthreaded. As the drive screw 225 and the load ring 235 are secured to the retainer 254 via the fastener 249, removal of the retainer 254 also removes the load ring 235 and the drive screw 225. Therefore, once the retainer 254 is fully unthreaded from the bore 250, the valve cover 252A can be accessed for removal or inspection.

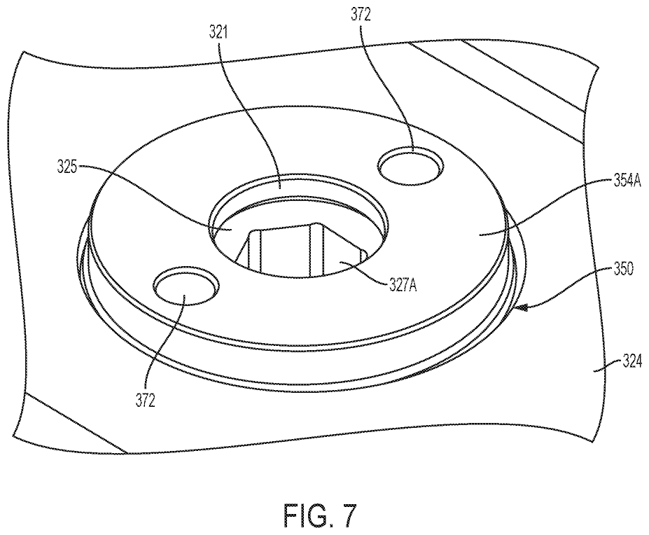

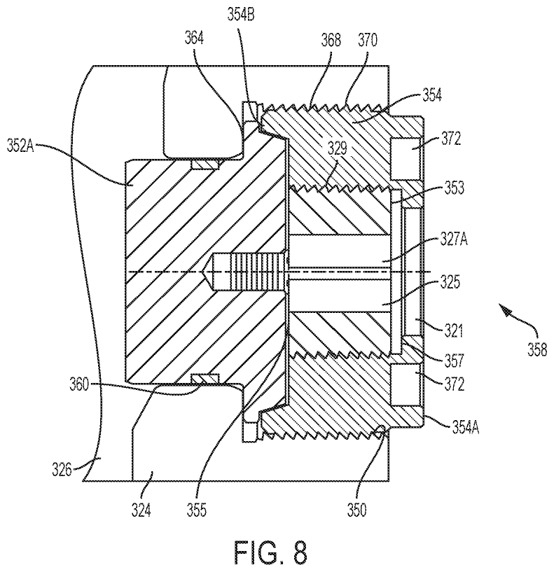

FIGS. 7-8 illustrate another embodiment of the invention. Like elements are indicated by like reference numerals incremented by 300 (relative to the embodiment shown in FIGS. 3-4) and are similar to those elements shown in FIGS. 3-4, 5, and 6 except as otherwise described.

As shown in FIGS. 7-8, the threaded drive member 325 is embodied as a drive nut and does not extend beyond the external first axial end 354A of the retainer 354. The drive nut 325 includes external threads 329 that engage internal threads 353 extending axially within the central opening 321 from the second axial end 354B of the retainer 354. The drive nut 325 includes an internal engagement feature 327A (e.g., having a hexagonal cross-section) that is engageable by an adjustment tool (e.g., a wrench) to rotate the drive nut 325 relative to the retainer 354. The drive nut 325 includes a planar surface 355 that is engageable with the valve cover 352A to apply an axial force on the valve cover 352A. The retainer 354 further includes a step 357 that prevents removal of the drive nut 325 from the central opening 321 from the first axial end 354A of the retainer 354.

In operation, to preload the removable valve cover 352A (or, alternatively, the removable valve cover 352B), the valve cover 352A is inserted into the bore 350 and is seated against the step 364, with the radial seal 360 blocking a leakage path from the interior volume 326 of the housing 324. The drive nut 325 is threaded onto the central opening 321 of the retainer 354 until the drive nut 325 is fully inserted so as to not interfere with the insertion of the retainer 354. The retainer assembly 358 is threaded onto the internal threads 368 of the bore 350 (e.g., via a spanner wrench in engagement with the engagement features 372) until the second axial end 354B of the retainer 354 engages (e.g., abuts, contacts) the valve cover 352A. Once the retainer 354 is in contact with the valve cover 352A, torque is applied to the drive nut 325 via the adjustment tool to tighten the drive nut 325 against the valve cover 352A. More specifically, the drive nut 325 is rotated; resulting in axial translation of the drive nut 325 into contact with the valve cover 352A and applying an axial force against the valve cover 352A (via the planar surface 355). This applied force is applied directly to the valve cover 352A and is also transferred through the retainer 354 to the interface between the threads 368, 370. Preloading the valve cover 352A prevents or limits seal movement when pressure is applied in the internal volume 326 of the housing 324.

In operation, to remove the retainer assembly 358, the drive nut 325 is rotated (e.g., by a wrench engaging the engagement feature 327A) to axially translate the drive nut 325 away from the valve cover 352A to remove the preload. Once the preload is fully removed by loosening the drive screw 325, the retainer 354 is rotated relative to the bore 350 until fully unthreaded. As the drive nut 325 is threaded and secured to the retainer 354, removal of the retainer 354 also removes the drive nut 325. Therefore, once the retainer 354 is fully unthreaded from the bore 350, the valve cover 352A can be accessed for removal or inspection.

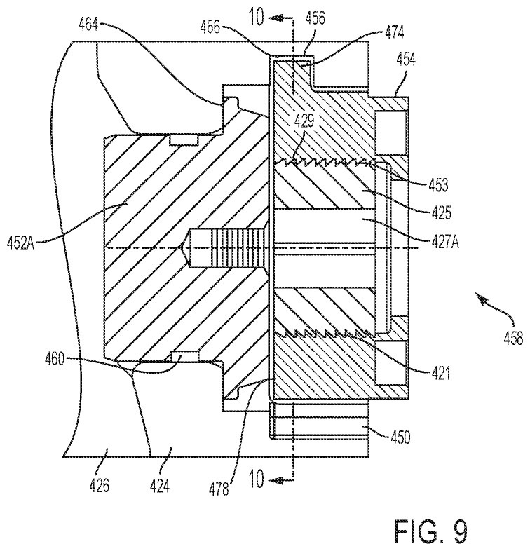

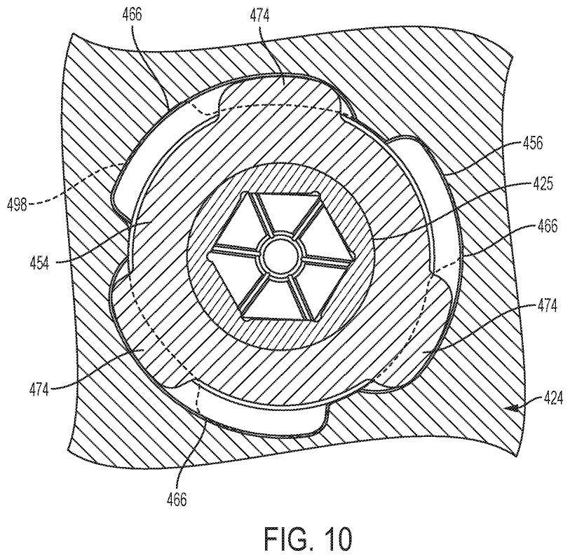

FIGS. 9-10 illustrates another embodiment of the invention. Like elements are indicated by like reference numerals incremented by 400 (relative to the embodiment shown in FIGS. 3-4) and are similar to those elements shown in FIGS. 3-4, 5, 6, and 7-8 except as otherwise described.

As shown in FIGS. 9-10, the bore 450 is modified relative to the bore 50 shown in FIGS. 3-8 to no longer include threads to be engaged by the retainer 454. The diameter and shape of the bore 450 vary along the length of the bore 450. Similar to the bore 50, the bore 450 includes a step 464 for supporting the valve cover 452A. Further, the bore 450 includes a recessed channel 456 having a non-circular cross-sectional area. The cross-sectional area of the recessed channel 456 includes three distinct recesses 466, each recess 466 spanning approximately 100 degrees, and narrowing therebetween. The recessed channel 456 is positioned at a depth within the housing 424 adjacent the step 464. The portion of the bore 450 between the exterior of the housing 424 and the recessed channel 456 is likewise non-circular, having recesses 498 (as illustrated in dashed lines in FIG. 10) similar to the distinct recesses 466 of the recessed channel 456, though narrower (e.g., approximately 45 degrees each). One radial edge of each recess 498 is aligned with a similar radial edge of the recess 466. The bore 450 is not a threaded bore. While only shown with the recesses 466 at a single axial depth within the bore 450, the bore 450 can otherwise be provided with recesses 466 at multiple depths to permit the retainer 454 to be coupled to the housing 424 at various depths.

As the bore 450 does not include threads for mating with a retainer 454, the retainer 454 is likewise modified to engage the bore 450. The retainer 454 includes three peripheral lobes 474 that extend radially outward from the remainder of the retainer 454. The peripheral lobes 474 are spaced equidistant from one another about the periphery of the retainer 454 and are sized to fit within the recesses 498. The retainer 454 can include more or less lobes 474 to appropriately coincide with the number of distinct recesses in the bore 450. In some embodiments, this may be referred to as a bayonet-style connection or bayonet connection.

While only shown having recesses 466 at a single axial depth within the bore 450, the bore 450 can otherwise be provided with recesses 466 at multiple depths to permit the retainer 454 to be coupled to the housing 424 at various depths. In some embodiments, this may be referred to as breach threads.

In operation, to preload the removable valve cover 452A, the valve cover 452A is inserted into the bore 450 and is seated against the step 464, with the radial seal 460 blocking a leakage path from the interior volume 426 of the housing 424. The external threads 429 of the drive nut 425 are threaded onto the internal threads 453 of the central bore 421 of the retainer 454. Once the drive nut 425 is threaded into the central bore 421, the retainer 454 is axially inserted into the bore 450, with the peripheral lobes 474 aligned with the recesses 498. Once the first axial end 478 of the retainer 454 reaches the appropriate depth (e.g., the first axial end 478 abuts the valve cover 452A, the retainer 454 is rotatable relative to the bore 450, etc.), the retainer 454 is rotated such that the peripheral lobes 474 are not aligned with the recesses 498, but are instead located within the recesses 466, misaligned with the recesses 498 in a locked position. Once in the locked position, torque is applied to the drive nut 425 to apply a preload force to the valve cover 452A. Preloading the valve cover 452A prevents or limits seal movement when pressure is applied in the internal volume 426 of the housing 424.

In operation, to remove the retainer assembly 458, the drive nut 425 is rotated (e.g., by a wrench engaging the engagement feature 427A) to axially translate the drive nut 425 away from the valve cover 452A to remove the preload. Once the preload is fully removed by loosening the drive nut 425, the retainer 454 is rotated relative to the bore 450 until the lobes 474 are aligned with the recesses 498. Once aligned, the retainer is axially removable from the bore 450. As the drive nut 425 is secured to the retainer 454 via the threaded connection, removal of the retainer 454 also removes the drive nut 425. Therefore, once the retainer 454 is fully unthreaded from the bore 450, the valve cover 452A can be accessed for removal or inspection.

Various features and advantages of the invention are set forth in the following claims.

What is claimed is:

1. A fluid end assembly of a hydraulic fluid pump comprising:
a housing having an axial bore;
a removable valve cover closing the axial bore;
a retainer engaging the axial bore, the retainer comprising a central opening; and
a threaded drive member positioned within the central opening and operable to apply a preload against the retainer.

2. The fluid end assembly of claim 1, wherein the axial bore includes internal threads and the retainer includes external threads, and wherein the external threads of the retainer engage the internal threads of the axial bore.

3. The fluid end assembly of claim 1, wherein the valve cover is a threaded valve cover, and wherein the threaded drive member is a drive screw having a plurality of threads that engage the threaded valve cover to apply the preload against the retainer.

4. The fluid end assembly of claim 1, further comprising a threaded load ring positioned between the threaded drive member and one or both of the retainer and the valve cover, wherein the threaded drive member is a drive screw having a plurality of threads that engage the threaded load ring to apply the preload against the retainer.

5. The fluid end assembly of claim 1, wherein the retainer is a threaded retainer, and wherein the threaded drive member is a drive nut having a plurality of threads that engage the threaded retainer to apply the preload against the retainer.

6. The fluid end assembly of claim 1, wherein the central opening is stepped, defining an annular surface of the retainer at a change in cross-sectional area between a first portion of the central opening and a second portion of the central opening, wherein the drive member includes a radial protrusion axially abutting the annular surface to apply the preload against the retainer.

7. The fluid end assembly of claim 1, wherein the drive member axially abuts the valve cover to apply the preload against the retainer.

8. The fluid end assembly of claim 1, further comprising a threaded load ring positioned between the retainer and the valve cover, the threaded load ring having a plurality of internal threads, wherein the threaded drive member includes a plurality of external threads that engage the plurality of internal threads of the load ring.

9. The fluid end assembly of claim 8, further comprising a fastener coupled to the retainer and operable to hold the load ring within a gap between the fastener and an annular surface of the retainer.

10. The fluid end assembly of claim 9, wherein the fastener is a snap ring.

11. The fluid end assembly of claim 8, wherein the valve cover includes a recess that is axially aligned with the central opening of the retainer, and wherein the threaded load ring is positioned within the recess of the valve cover.

12. The fluid end assembly of claim 1, wherein the valve cover includes an opening and wherein the threaded drive member extends axially into the opening.

13. A method of assembling a fluid end assembly of a hydraulic fluid pump, the method comprising
inserting a removable valve cover into an axial bore of a housing of the fluid end assembly, the removable valve cover closing and sealing the axial bore;
engaging a threaded drive member with one of the valve cover or a retainer;
engaging the retainer with the axial bore of the housing;
positioning the threaded drive member within a central opening of the retainer; and
applying a preload against the retainer by rotating the threaded drive member relative to the retainer and the valve cover.

14. The method of claim 13, wherein engaging the threaded drive member with one of the valve cover or the retainer includes directly threading the threaded drive member with one of the valve cover or the retainer.

15. The method of claim 13, wherein engaging the threaded drive member with one of the valve cover or the retainer includes indirectly engaging one of the valve cover or the retainer by threading the threaded drive member with a load ring, and engaging the load ring with the valve cover.

16. The method of claim 13, wherein applying a preload against the retainer by rotating the threaded drive member includes translating the threaded drive member axially away from the valve cover.

17. The method of claim 16, wherein applying the preload includes applying an axial force against an annular surface of the retainer.

18. The method of claim 13, wherein applying a preload against the retainer by rotating the threaded drive member includes translating the threaded drive member axially toward the valve cover, and wherein applying the preload includes applying an axial force against the valve cover.

19. The method of claim 13, wherein, prior to engaging the retainer with the axial bore of the housing, the method further comprises, positioning a load ring within a recess of retainer and coupling a fastener to the retainer to prevent removal of the load ring, such that engaging the retainer with the axial bore of the housing further comprises inserting the load ring and the fastener into the axial bore.

20. The method of claim 13, wherein engaging the retainer with the axial bore of the housing includes rotating the retainer relative to the axial bore.
